(19) United States
(12) Patent Application Publication
(10) Pub. No.: US 2026/0104606 A1
(43) Pub. Date: Apr. 16, 2026

(54) Optical Transmitter

(71) Applicant: Nippon Telegraph and Telephone Corporation, Tokyo (JP)

(72) Inventors: Josuke Ozaki, Musashino-shi, Tokyo (JP); Yoshihiro Ogiso, Musashino-shi, Tokyo (JP); Mitsuteru Ishikawa, Musashino-shi, Tokyo (JP)

(21) Appl. No.: 19/114,733

(22) PCT Filed: Oct. 3, 2022
(86) PCT No.: PCT/JP2022/037029

§ 371 Date: Mar. 24, 2025

(51) Int. Cl. G02F 1/03

(52) U.S. Cl. CPC G02F 1/0344; G02F 2203/21

(57) ABSTRACT

An optical transmitter includes: an optical modulator; a driver integrated circuit (driver IC) that supplies a modulation electrical signal for the optical modulator; a first wiring board mounted face down by flip-chip mounting to connect the optical modulator and the driver IC; a first Peltier device configured to control a temperature of the optical modulator; and a second Peltier device configured to control a temperature of the driver IC.

### TECHNICAL FIELD

The present invention relates to an optical transmitter used in optical communication. More particularly, the present invention relates to an implementation form of an optical transmitter including a semiconductor optical modulator and a driver IC thereof.

### BACKGROUND ART

In order to cope with a rapid traffic increase of a communication network, digital coherent optical transmission combining a coherent communication scheme and a digital signal processing technology has been introduced into an optical fiber communications system. Starting from the establishment of a backbone network transmission technology of 100 Gbps per wavelength at the beginning, transmission of 400 Gbps to 600 Gbps per wavelength, which is faster, has been put into practical use at present.

In the above-described digital coherent optical transmission, an optical transmission/reception device in which an optical receiver and an optical transmitter are integrated is used. In the optical transmission/reception device of a system having a transmission capacity exceeding 400 Gbps, an analog component such as a radio frequency (RF) electric circuit is required to have a wide bandwidth. For example, in an optical modulator, a modulation bandwidth of 40 GHZ or more is required. In order to reduce a high-frequency loss and downsize a device, which leads to having a wide bandwidth, for example, a form in which an RF driver IC and an optical modulator are mounted in an integrated package on a transmission side has attracted attention. An implementation form of this optical transmitter is also standardized by the Optical Internetworking Forum (OIF) under the name of High-Bandwidth Coherent Driver Modulator (HB-CDM) (Non Patent Literature 1). On a reception side of the optical transmission/reception device, a transimpedance amplifier (TIA) and an optical receiver are mounted in an integrated package, which is also referred to as an integrated coherent receiver (ICR).

Turning to materials for an optical transmitter/receiver device, a semiconductor-based optical modulator has attracted attention instead of a conventional lithium niobate (LN) optical modulator in terms of miniaturization and cost reduction. For higher-speed modulation operation, a compound semiconductor represented by InP is mainly used. Furthermore, research and development are concentrated on a Si-based optical device in a system with emphasis on miniaturization and cost reduction.

There are advantages and disadvantages inherent to materials in the above-described semiconductor-based optical modulator, and for example, in an InP optical modulator, temperature control of an optical modulator chip is essential at the time of operation in order to control a band-edge absorption effect. On the other hand, the Si optical modulator has a merit that the temperature control is unnecessary, but has a smaller electro-optical effect than other material systems. For this reason, it is necessary to increase the electro-optical interaction length, and as a result of increasing the device length, a high-frequency loss may be increased. There are many problems in achieving the higher speed and wide bandwidth of the optical modulator in addition to the implementation technology for the wide bandwidth and miniaturization.

The operation temperature (case temperature) of the optical transmitter with the HB-CDM is required to be in a range of at least −5° C. to 75° C. In order to obtain the operation temperature, generally, only the optical modulator chip is mounted on a Peltier device in consideration of power consumption (Patent Literature 1).

### CITATION LIST

### Patent Literature

Patent Literature 1: WO 2021/171599 A

Patent Literature 2: Japanese U.S. Pat. No. 6,770,478

### Non Patent Literature

Non Patent Literature 1: OIF, Implementation Agreement for the High Bandwidth Coherent Driver Modulator (HB-CDM), [online], Jul. 15, 2021, [retrieved on September 1, 2022], Internet <URL: https://www.oiforum.com/wp-content/uploads/OIF-HB-CDM-02.0.pdf>

Non Patent Literature 2: J. Ozaki et al., “500-Gb/s/λ Operation of Ultra-Low Power and Low-Temperature-Dependence InP-Based High-Bandwidth Coherent Driver Modulator,” in Journal of Lightwave Technology, vol. 38, no. 18, pp. 5086-5091, 15 Sept. 15, 2020, doi:10.1109/JLT.2020.2998466.

### SUMMARY OF INVENTION

### Technical Problem

However, in the optical transmitter of the related art, deterioration of high-frequency characteristics of the driver IC at a high temperature has been a problem. Specifically, in a case where the environmental temperature is high, there has been a problem that the high frequency bandwidth, peaking amount, and gain of the driver IC deteriorate. In achieving the speed increase and wide bandwidth of the optical transmitter, the influence of a decrease in signal quality due to the above-described deterioration cannot be ignored. Therefore, an optical transmitter capable of maintaining a constant high-frequency characteristics regardless of a change in an environmental temperature is desired.

In view of the above-described problems, the present invention provides a novel configuration and an implementation form of an optical transmitter that suppresses temperature dependency of an optical transmitter including a driver IC, is excellent in speed, and is capable of stably operating regardless of the environmental temperature.

### Solution to Problem

According to one aspect of the present invention, there is provided an optical transmitter including: an optical modulator; a driver integrated circuit (driver IC) that supplies a modulation electrical signal for the optical modulator; a first wiring board that connects the optical modulator and the driver IC, and is mounted face down by flip-chip mounting; a first Peltier device that controls a temperature of the optical modulator; and a second Peltier device that controls a temperature of the driver IC.

### Advantageous Effects of Invention

In view of the above-described problems, the present invention provides a novel configuration and an implementation form of an optical transmitter that suppresses temperature dependency of an optical transmitter including a driver IC, is excellent in speed, and is capable of stably operating regardless of the environmental temperature.

### BRIEF DESCRIPTION OF DRAWINGS

FIG. 1 is a side cross-sectional view illustrating an implementation form of a conventional HB-CDM.

FIG. 2 is a side cross-sectional view illustrating an implementation form of an optical transmitter using an HB-CDM of the present invention (first embodiment).

FIG. 3 is a top view illustrating a modified implementation form of an optical transmitter of the present invention.

FIG. 4 is a side cross-sectional view illustrating an implementation form of an optical transmitter using an HB-CDM of the present invention (second embodiment).

FIG. 5 is a side cross-sectional view illustrating an implementation form of an optical transmitter using an HB-CDM of the present invention (third embodiment).

FIG. 6 is a side cross-sectional view illustrating an implementation form of an optical transmitter using an HB-CDM of the present invention (fourth embodiment).

FIG. 7 is a side cross-sectional view illustrating an implementation form of an optical transmitter using an HB-CDM of the present invention (fifth embodiment).

FIG. 8 is a diagram (example) for describing density arrangement of a Peltier device in an optical transmitter of the present invention.

### DESCRIPTION OF EMBODIMENTS

Hereinafter, embodiments of the present invention will be described with reference to the drawings.

Portions having the same functions are denoted by the same reference numerals in the drawings, and description thereof will be omitted.

### First Embodiment

The present invention presents a new configuration for improving temperature dependency of high-frequency characteristics of an optical transmitter, and an implementation form adapted to each configuration in an optical transmitter in which an optical modulator and a driver IC thereof are integrally packaged. The configuration for improving the temperature dependency includes a new application form of a temperature regulator (thermoelectric cooler (TEC)) in the optical transmitter. Moreover, various implementation forms of a driver IC, an optical modulator chip and a spatial optical component, which are adapted to a new application form of the TEC are also proposed.

The TEC is also called a thermoelectric cooler, and is known as a small cooling device by Peltier junction. The TEC includes an n-type semiconductor, a p-type semiconductor, and a metal, and when a direct current flows through both surfaces of an element formed in a plate shape, heat absorption occurs on one surface and heat dissipation occurs on the other surface. When the direction of the current is reversed, the heat absorption and the heat dissipation are switched. Therefore, local and accurate temperature control for the IC and the electronic component is possible. In the following description, the temperature regulator is referred to as a TEC for simplicity, and will be described as a Peltier device. As long as the temperature of the driver IC or the optical modulator chip can be controlled, the present invention is not limited to the Peltier device.

In the following, the problem of the temperature dependency of the high-frequency characteristics in the optical transmitter will be first described with an optical modulator using the HB-CDM of the related art as an example. Thereafter, a novel configuration for improving the temperature dependency of the high-frequency characteristics with the optical transmitter of the present invention will be described together with various implementation forms.

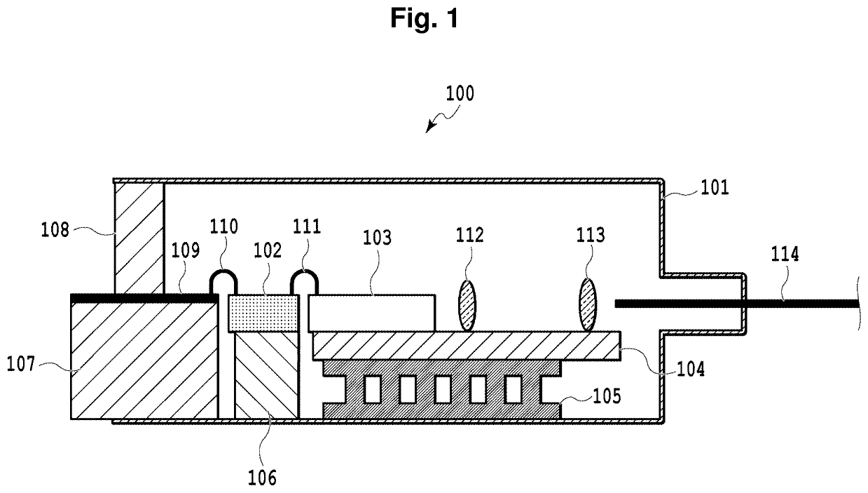

FIG. 1 is a side cross-sectional view illustrating an implementation form of the optical transmitter using the HB-CDM of the related art. In an optical transmitter 100, a driver IC 102, an optical modulator chip 103, lenses 112 and 113 which are spatial optical components, and the like are housed inside a package housing 101 made of ceramic, metal, or the like, or a combination thereof, according to the specification of the HB-CDM. More specifically, the optical modulator chip 103 is mounted on the bottom surface inside the housing 101 via a subcarrier 104 on a Peltier device 105. At the right end of the optical modulator chip 103 in the drawing, there is an emission end face of the modulation light, and the lenses 112 and 113 for optically coupling the modulation light with an optical fiber 114 are also mounted on the subcarrier.

The driver IC 102 is mounted on a metal block or a ceramic member 106 adjacent to the optical modulator chip 103. Moreover, a wiring board base 107 and a package wall surface 108 are provided as wall surfaces on the left side of the package housing 101 in the drawing, and define the outside and the internal space of the optical transmitter together with the package housing 101. The optical transmitter 100 can be configured such that the entire package ensures airtightness.

A modulation electrical signal supplied from an external digital signal processor (DSP) is supplied to the optical modulator chip 103 via a wiring layer 109 of the wiring board base 107 and the driver IC 102. The wiring layer 109 and the driver IC 102, and the driver IC 102 and the optical modulator chip 103 are connected by gold wire lines 110 and 111, respectively. In a case of the polarization multiplexing type IQ optical modulation scheme, the modulation electrical signal includes an I channel and a Q channel for X polarization and Y polarization. In a case where one channel is supplied as a differential signaling electrical signal, at least eight signal wirings and a GND wiring are required for one optical modulator, but the modulation signaling is not limited thereto. As described in Patent Literature 1, the optical transmitter 100 illustrated in FIG. 1 is mounted on a common device substrate together with an ICR package or a DSP in which the TIA and the optical receiver on the reception side are integrated, and can constitute an optical transmission/reception device.

Here, attention is again focused on the Peltier device 105 in the optical transmitter. Temperature control is essential for the optical modulator chip 103 prepared on an InP substrate, and the temperature is controlled to a predetermined operation temperature by the Peltier device 105. As illustrated in FIG. 1, the Peltier device 105 has a size that covers at least the entire region of the optical modulator chip 103, and its position may overlap a region of the spatial optical component such as a lens. On the other hand, in the optical transmitter 100 of the related art, it is considered that the temperature control of the driver IC 102 is not necessary, and the optical transmitter is fixed in the package by a member 106 such as a metal block or a ceramic member. When the external temperature (environmental temperature) of the optical transmitter 100 increases, the increased temperature becomes the operation temperature of the driver IC 102. Actually, since the driver IC is also a heating element, in consideration of heat generation from the driver, it is estimated that the operation temperature of the driver IC is higher than the external temperature by about +5° C. to 10° C. When the maximum environmental temperature at which the optical transmission/reception device including the optical transmitter is used is 85° C., the temperature of the driver IC 102 itself is at least 85° C. or higher. The driver IC also has large power consumption, and the driver IC itself generates heat. This means that the back side temperature of the driver IC exceeds the maximum environmental temperature of 85° C. due to the influence of heat generation of the driver IC.

The driver IC has temperature dependency of amplification characteristics (high-frequency characteristics) of a radio frequency electrical signal, and in a high temperature state, a high frequency bandwidth tends to decrease as compared with a room temperature state. Conversely, in a low temperature state, the high frequency bandwidth tends to increase as compared with the room temperature state. As described above, the high-frequency characteristics of the driver IC are different between the low temperature state and the high temperature state. The modulation signal supplied to the driver IC is variously optimized and compensated by the DSP in the room temperature state. However, performing such compensation while dynamically performing update with temperature variation is complicated processing and is not generally performed. Since the operation is continued in a constant compensation state at the room temperature, the compensation state of the modulation signal deviates from the optimum point when the state changes to the low temperature state or the high temperature state. Therefore, optical transmission characteristics and waveform quality of the optical transmitter fluctuate or deteriorate.

The IQ modulator of the optical modulator chip 103 is a linear modulator that preserves the amplitude and phase of the electrical signal, and variations in the level and waveform quality of the modulation electrical signal directly affect the quality of the modulation output light. When the external temperature changes during the operation of the optical transmitter, the optical modulator chip itself is maintained at a constant temperature since the temperature is controlled by the Peltier device, but the operation temperature of the driver IC changes. As a result, there is also a problem that a level variation and a quality variation of the modulation light of the HB-CDM occur, and since the environmental temperature temporally changes, transmission characteristics are deteriorated and are not stable.

The characteristic deterioration caused by the environmental temperature on the high-frequency side of the electrical signal causes waveform distortion of the modulation signal, and the modulation accuracy of the modulation output light from the optical modulator is deteriorated. In the optical receiver that receives such deteriorated modulation light, a BER floor appears in BER characteristics, which leads to deterioration of transmission characteristics of a system.

The influence of deterioration of the high-frequency characteristics of the driver IC at high temperature as described above cannot be ignored in a situation where a modulation bandwidth of 40 GHz or more is required as the request for widening the bandwidth of the modulation electrical signal is made. The present invention presents a new configuration and an implementation form for improving temperature dependency in high-frequency characteristics and optical transmission characteristics in the optical transmitter in which the optical modulator and the driver IC thereof are integrally packaged.

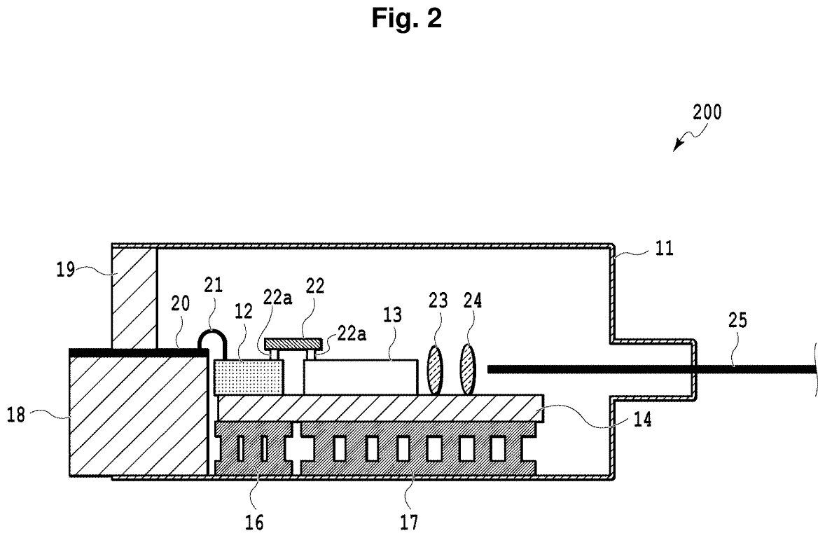

FIG. 2 is a side cross-sectional view illustrating an implementation form of an optical transmitter 200 using the HB-CDM of the present invention. In the optical transmitter 200 of the present invention, similarly to the configuration of the related art illustrated in FIG. 1, an optical modulator chip 13 made of InP, a driver IC 12 thereof, and the like are integrated in a package housing 11 for the HB-CDM. A wiring board base 18 and a package wall surface 19 are provided as wall surfaces on the left side of the package housing 11 in the drawing, and the inside and the outside of the package are similarly defined. A difference from the configuration of the related art in FIG. 1 is an application form of the TEC that performs temperature control, that is, the Peltier device. Unlike the application form of the Peltier device in FIG. 1, the driver IC 12 is also mounted on a second Peltier device 16. The second Peltier device 16 of the driver IC 12 is separate and independent from a first Peltier device 17 that performs temperature control of the optical modulator chip 13, and the optical transmitter 200 includes two Peltier devices.

The optical modulator chip 13 and lenses 23 and 24 are mounted on the first Peltier device 17 via a subcarrier 14.

The subcarrier 14 functions as a base for fixing and holding the optical modulator chip and the spatial optical component.

It is desirable that a material of the subcarrier 14 is excellent in thermal conductivity since the optical modulator chip 13 to be subjected to temperature control is mounted. As described above, considering both handling of a DC wiring and the like and thermal conductivity, a substrate composed of a dielectric instead of a metal is desirable, and for example, a ceramic substrate such as an AlN substrate is preferable. In particular, since the AlN substrate has a material constant close to that of InP, the AlN substrate is compatible with the optical modulator using InP also in terms of behavior relative to temperature change. From the same reason and the viewpoint of material consistency, it is desirable that the ceramic member on the upper surface of the first Peltier device 17 is also composed of AlN.

Furthermore, the subcarrier 14 may be a metal block, and in a case where the metal block is used, CuW or the like having excellent heat dissipation is preferably employed.

In FIG. 2, the carrier 14 is drawn to be constituted by one layer, but may be constituted by a multilayer in a case where the carrier 14 is constituted by a dielectric substrate. In a case where the number of DC wirings provided to the optical modulator is large, or in a case where it is necessary to perform cross wiring for switching the order of terminals, it is possible to make a flexible element/wiring layout using a multilayer wiring by using the multilayer. Furthermore, in a case where the dielectric substrate is used, a positioning marker or the like for mounting the spatial optical component can be formed with a metal pattern.

Furthermore, in a case where wiring or the like for taking out the DC wiring of the optical modulator chip to the carrier 14 is essential, the carrier 14 may be constituted by only the dielectric substrate (may be a single layer or a multilayer), or the carrier 14 may be constituted by both the metal block and the dielectric substrate. In a case where the carrier 14 is constituted by both the metal block and the dielectric substrate, a dielectric substrate for forming a wiring is only required to be provided on at least a part of the upper surface of the carrier 14.

More specifically, in a case where no mark or no wiring may be provided, the subcarrier 14 can be constituted by only the metal block, and can be constituted by placing the AlN substrate on the metal block. The size of the AlN substrate may be the same as that of the metal block, and a small AlN substrate may be installed beside the chip or the like.

The driver IC 12 whose temperature is controlled independently of the optical modulator chip 13 is also desirably mounted on the second Peltier device 16 via a holding member 15 in order to align the height with a RF terrace corresponding to the upper surfaces of the optical modulator chip 13 and the wiring board base 18. As the holding member 15, a metal block, a ceramic substrate, or the like can be used. In consideration of thermal conductivity, for example, in a case where the DC wiring is unnecessary in the driver IC 12, a metal block such as a CuW block can be used, and in a case where the DC wiring of the driver is necessary, a ceramic such as an AlN substrate can also be used. In a case where the AlN substrate is used, the number of wirings provided to the driver IC is large, and the wiring is complicated, a multilayer substrate can also be used similarly to the subcarrier 14 of the optical modulator chip described above.

As described above, the driver IC is a heating element, and is not considered as an object to be temperature-controlled by the Peltier device. Driving power is required to operate the Peltier device, and it is not considered to use extra power for the heating element. However, in order to realize the wide bandwidth of the optical transmitter, the inventors have made a new idea of controlling the temperature of the heating element.

The optical transmitter 200 of the present invention includes the second Peltier devices 16 and the first Peltier device 17 that are independently controlled as described above, such that the temperature of the driver IC 12 and the temperature of the optical modulator chip 13 can be independently controlled. Although not explicitly illustrated in FIG. 2, two Peltier devices are connected to separate control current sources. For a specific control temperature of each part, the InP optical modulator is desirably used generally at about 45±10° C. since the modulation efficiency decreases when the temperature is too low.

On the other hand, for the driver IC 12, it is known that the high-frequency characteristics are better in the low temperature state than in the high temperature state, and it is desirable as the set temperature is lower. However, even when the set temperature is too low, the improvement of the high-frequency characteristics of the driver IC is limited while the power consumption in the Peltier device is increased. Therefore, for example, it is most appropriate to operate the driver IC at 30±10° C. near room temperature from the viewpoint of achieving both power consumption and high-frequency characteristics. By independently setting the optical modulator chip 13 and the driver IC 12 to different temperatures, it is possible to realize an optical transmitter that can operate in an optimum state for each of the optical modulator chip 13 and the driver IC 12. However, in a case where the power consumption can be ignored and transmission characteristics are prioritized, it is desirable as the temperature is lower, and thus the present invention is not limited thereto.

Therefore, the optical transmitter 200 of the present invention can be implemented as an optical transmitter including an optical modulator chip 13, a driver integrated circuit (driver IC 12) that supplies a modulation electrical signal for the optical modulator, a first wiring board 22 that connects the optical modulator and the driver IC 12, and is mounted face down by flip-chip mounting, a first Peltier device 17 that controls a temperature of the optical modulator, and a second Peltier device 16 that controls a temperature of the driver IC.

Between the members whose temperatures are controlled by the Peltier devices, it is necessary to mount a conductive paste or solder having thermal conductivity of 30 W/mK or more and excellent thermal conductivity in order to improve heat dissipation by the Peltier device. For the management of the manufacturing process temperature and the like of a module, the same conductive paste and solder may be used, or those having different fixing temperatures and the like may be used in combination.

In the optical transmitter 200 of FIG. 2, the second Peltier device 16 and the first Peltier device 17 control the temperature of the driver IC and the temperature of the optical modulator chip via the common subcarrier 14. Since the driver IC and the optical modulator chip are connected via the subcarrier 14, the temperature of the driver IC and the temperature of the optical modulator chip cannot be completely independently controlled. However, the first Peltier device 17 can significantly prevent the temperature of the driver IC 12 from being high and improve the high-frequency characteristics. Furthermore, by using the single subcarrier 14, the member cost can be suppressed and the mounting process can be simplified. For example, in order to realize the independent control, as described later, it is also effective to provide a groove for thermal separation on one of the upper surface and the bottom surface of the subcarrier 14 or on both the upper surface and the bottom surface to realize thermal separation between the optical modulator and the driver IC.

All the spatial optical components such as the lenses 23 and 24 are mounted on the first Peltier device 17 in order to suppress the thickness variation of an adhesive due to a temperature change. Thus, it is possible to minimize fluctuation of the optical insertion loss and the like caused by the deviation of the optical axis due to the temperature change. Note that examples of the spatial optical component includes a fiber fixing member, and a polarization beam combiner (PBC).

Although FIG. 2 illustrates the optical transmitter 200 using the HB-CDM as an example, the same effect can be obtained even in the case of using other package forms as long as an optical transmission module is constituted in which the driver IC and the optical modulator are integrally configured. Furthermore, FIG. 2 illustrates an example in which a wiring from a DSP that supplies a modulation signal to the driver IC 12 is connected on the RF terrace by a flexible printed circuit (FPC). That is, a metal pattern 20 on the upper surface of the wiring board base 18 outside the optical transmitter is connected to an FPC cable (not illustrated). Since a FPC interface does not require an RF via (VIA) or the like as compared with a configuration using a surface mount technology (SMT), the FPC interface is excellent in high-frequency characteristics.

Next, a mounting structure for ensuring high-frequency characteristics of the driver IC, the optical modulator, and the like will be described. In the optical transmitter 200 using the HB-CDM illustrated in FIG. 2, the electrode pad of the driver IC and the electrode pad of the RF terrace, and the electrode pad of the driver IC and the electrode pad of the optical modulator are connected by a wire 21, a wiring board (first wiring board) 22, and a first pillar/bump 22a, respectively. As the series inductance component of the connection portion between the driver IC 12 and the optical modulator chip 13 increases, a roll-off frequency in the high-frequency characteristics shifts to the low-frequency side due to LC resonance. Therefore, in order to suppress deterioration of high-frequency characteristics in the driver IC and realize a wide bandwidth HB-CDM, it is important to reduce the inductance of the connection portion. Therefore, in the optical transmitter 200, the inductance becomes high in the connection between the driver IC and the modulator, and thus the wiring board (first wiring board) 22 is used without using a generally used wire. Thus, the inductance of the connection portion can be reduced, and the wide bandwidth can be achieved. Furthermore, as described above, the inductance between the driver IC and the modulator significantly affect the high-frequency characteristics, but the inductance between the driver IC and the RF terrace has a smaller influence than that of the former inductance. Therefore, the connection portion between the driver IC and the modulator has the highest priority as the importance, and the connection portion between the driver IC and the RF terrace is the second highest as the inductance.

In the present embodiment, a configuration in which first wiring board 22 is mounted face down by flip-chip mounting is provided between the driver IC 12 and the optical modulator chip 13, and the driver IC 12 and the metal pattern 20 on the wiring board base 18 are connected by the wire 21. Thus, the inductance of the connection portion between the driver IC 12 and the optical modulator chip 13 can be reduced. Therefore, the wide bandwidth HB-CDM can be realized.

Furthermore, from the viewpoint of the high-frequency characteristics, in order to best utilize the characteristics of the driver IC 12, it is desirable that both the driver IC 12 and the optical modulator chip 13 form a differential line configuration, and a radio frequency (RF) differential line having a bent shape greatly deteriorates characteristics. Therefore, the high-frequency line on the wiring board is desirably formed in a substantially linear shape. In order to form the substantially linear shape, it is desirable that a connection PAD pitches of members match as much as possible.

The first wiring board 22 is flip-chip mounted face down on a portion between the driver IC 12 and the optical modulator chip 13 by using the first pillar/bump 22a made of Au, Cu, or the like, and in order to perform stable mounting, it is desirable that the height of the upper surface of the driver IC 12 and the height of the upper surface of the optical modulator chip 13 match each other, and the bottom surface of the first wiring board 22 is mounted on the upper surface of the driver IC 12 or the upper surface of the optical modulator chip 13 without inclination (with flat). Solder or the like may be provided at the distal end of the pillar/bump in order to ensure connection strength or the like.

For example, when the inclination of the main surface (bottom surface) of the first wiring board 22 in the height direction relative to the main surface (upper surface) of the driver IC 12 or the main surface (upper surface) of the optical modulator chip 13 exceeds ±3°, there is a possibility that it is difficult to perform proper bonding due to generation of a gap or the like at the time of initial connection, or a load applied to the bonding portion increases and the connection portion is broken by the load, and thus it is difficult to ensure reliability. Therefore, it is very important to manage a tolerance, for example, the management is performed such that the inclination of the bottom surface of the first wiring board 22 in the height direction relative to the upper surface of the driver IC 12 and the upper surface of the optical modulator chip 13 is within ±3° and the bottom surface of the first wiring board 22 is not inclined at the time of mounting each member, and the heights of the members are adjusted such that the height of the upper surface of the driver IC 12 and the height of the upper surface of the optical modulator chip 13 match each other.

Regarding the difference in height between the upper surface of the driver IC 12 and the upper surface of the optical modulator chip 13, the first pillar/bump 22a made of Au, Cu, or the like, which is generally used, is 100 μm or less in both diameter and height. Therefore, the difference in height between the upper surface of the driver IC 12 and the upper surface of the optical modulator chip 13 is desirably controlled to 100 μm or less (ideally 50 μm or less).

For example, in a case where the driver IC 12 and the optical modulator chip 13 are mounted on the same subcarrier, the thickness of the driver IC 12 and the thickness of the optical modulator chip 13 need to be the same. By making the thickness of the driver IC and the thickness of the modulator chip the same, the height of the upper surface of the driver IC 12 and the height of the upper surface of the optical modulator chip 13 can be made the same. Since the same carrier is used, it can be said that the configuration is the most advantageous in terms of the number of members and a tolerance.

However, considering heat inflow from the driver IC to the modulator chip, from the viewpoint of thermal separation, it is not very desirable to mount the driver IC and the modulator chip on the same subcarrier as described above, and it is desirable to use carriers for the driver IC and the modulator chip as separate members as will be described later. Furthermore, in the case of using the same board, it is desirable to have a configuration in which a thermal separation groove is provided as will be described.

In a case where the driver IC 12 and the optical modulator chip 13 are mounted via separate members, the heights of the outermost surfaces connected to the driver IC 12 and the wiring board of the optical modulator chip 13 can be made to match each other by controlling the thicknesses of the members on which the driver IC 12 and the optical modulator chip 13 are mounted. In this case, the carrier itself may be a separate member, or the carrier as an integrated member may be adjusted by providing a step or the like according to the thickness of the driver IC and the thickness of the modulator chip.

From the viewpoint of minimizing the variation in height difference between the upper surface of the driver IC 12 and the upper surface of the optical modulator chip 13, it is most desirable that the optical modulator chip 13 and driver IC 12 having the same chip thickness are mounted on the same subcarrier. For example, when the thickness of the driver IC 12 is 300 μm, the chip thickness of the optical modulator chip 13 is merely required to be 300 μm.

Next, the configuration of the connection portion between the driver IC and the RF terrace will be described. As described above, the influence of the inductance between the driver IC and the RF terrace is smaller than the influence of the inductance between the driver IC and the modulator, and thus, FIG. 2 illustrates connection by a wire. In a case where the driver IC 12 and the metal pattern 20 on the wiring board base 18 are connected by a wire, it is desirable to suppress a difference between the height of the upper surface of the metal pattern 20 on the wiring board base 18 and the height of the upper surface of the driver IC 12 to about 100 μm from the viewpoint of stabilizing the wire length and mounting stability. Moreover, when considering wire connection by the ball bonding method, from the viewpoint of minimizing the wire length, it is desirable that the upper surface side of the driver IC 12 is set to be lower than the upper surface of the metal pattern 20 on the wiring board base 18, and the wire is connected from the driver IC 12 to the metal pattern 20 side on the wiring board base 18.

Next, considering the viewpoint of heat inflow from the driver IC 12 to the optical modulator chip 13 and interference of a jig or the like at the time of mounting, the distance between the driver IC 12 and the optical modulator chip 13 is desirably 300 μm or more. Furthermore, it can be said that the first wiring board 22 is desirably, for example, an AlN substrate in terms of matching linear expansion coefficients with the InP modulator. However, the AlN substrate is excellent in thermal conductivity, and thus it is desirable to use a SiO₂ substrate or a resin substrate using another dielectric material, which have low thermal conductivity, from the viewpoint of suppressing the heat inflow from the driver IC 12 to the optical modulator chip 13.

On the other hand, from the viewpoint of strength at the time of bonding and from the viewpoint of deterioration of high-frequency characteristics, it is desirable that the length of the first wiring board 22 is set to 2 mm or less at the longest, and it is more advantageous from the viewpoint of high frequency as the value of a dielectric constant or a dielectric loss tangent is smaller.

In addition to the substrate formed of the above-described material, the same effect can be obtained by using a ceramic substrate such as an alumina substrate in addition to the AlN substrate.

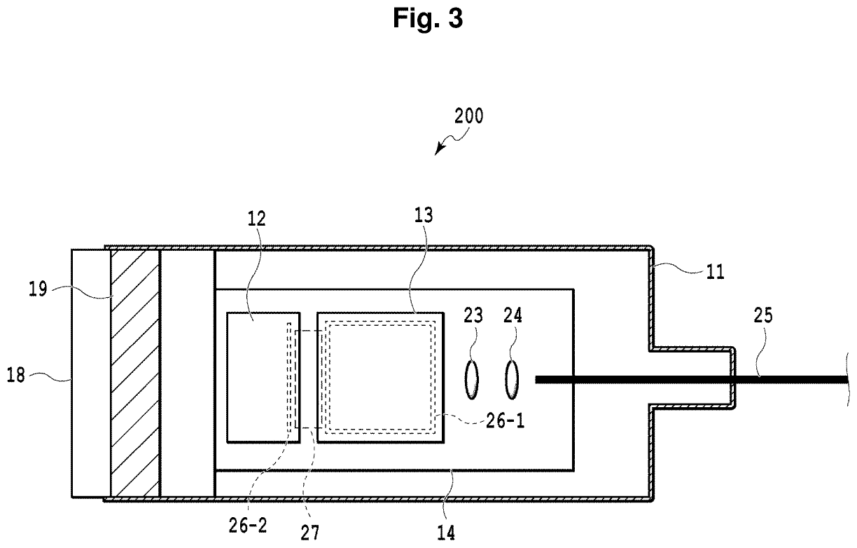

FIG. 3 is a top view illustrating a modification example of an implementation form of the optical transmitter of the present invention. This corresponds to a top view of a circuit surface inside a module when a housing 11 of the optical transmitter 200 illustrated in FIG. 2 is cut. In order to prevent an underfill material from flowing into a high frequency signal line of the subcarrier 14, grooves 26-1 and 26-2 are formed on the upper surface of the subcarrier 14 as indicated by dotted lines. The high frequency wiring of the subcarrier 14 is configured in a dotted line region 27 between the driver IC 12 and the optical modulator chip 13. In the driver IC 12 and the optical modulator chip 13, RF connection electrode pads are respectively formed around the driver IC and the optical modulator chip. By forming grooves on the upper surface of the subcarrier 14 at a position inside the electrode pads around these, an excess underfill material in the manufacturing process is accommodated in the grooves. The excess underfill material can be accommodated in the grooves without spreading over the IC and the high frequency wiring around the chip.

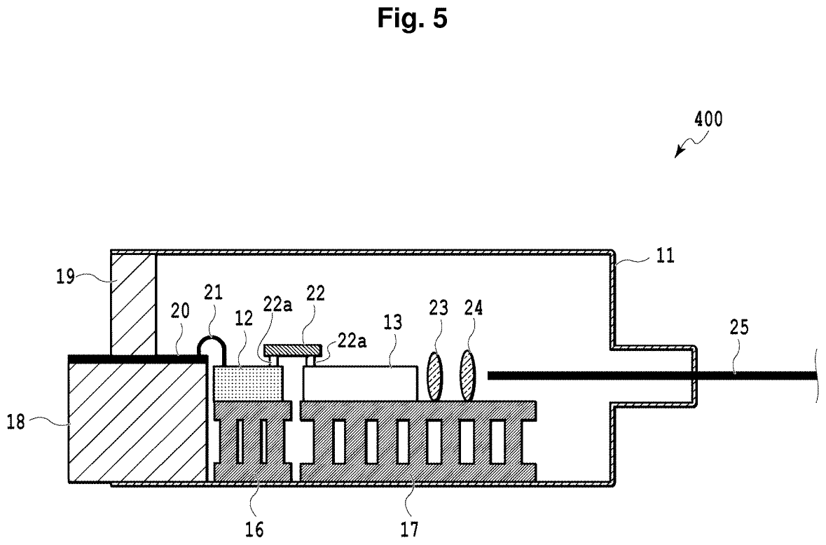

FIG. 3 illustrates an example in which the linear groove 26-2 is formed only on one side of the region 27 of the high frequency wiring in the driver IC 12, and a rectangular groove 26-1 is formed near four sides of the chip in the optical modulator chip 13. The shapes of the grooves are not limited to the configuration illustrated in FIG. 3, and can be changed according to the property of the underfill material, the form of the wiring on the subcarrier not to be affected, and the like. For example, in FIG. 3, the groove 26-2 of the driver IC 12 is provided only on one side on the optical modulator chip side, but may be formed in a rectangular shape around four sides of the driver IC. Furthermore, in addition to the configuration of FIG. 3, a linear groove may be added to one side of the driver IC 12 on the RF terrace side, that is, on the wiring board base 18 side. Moreover, in FIG. 5, the rectangular groove 26-1 is formed around four sides of the optical modulator chip 13, but the groove may be formed only on two sides of the driver IC side and the lens side to be described below.

The linear groove 26-2 of the driver IC 12 and a groove on the driver IC side in the rectangular groove 26-1 of the optical modulator chip 13 also serve as thermal separation grooves between the optical modulator chip and the driver IC. That is, a groove can be provided on the surface of the subcarrier 14 in the vicinity of at least one of the facing sides of the driver IC 12 and the optical modulator chip 13. In the optical transmitter of the present invention in which the second Peltier device 16 and the first Peltier device 17 operate via the common subcarrier 14, the groove described above can improve the independence of the temperature control, and the driver IC 12 can significantly reduce the high temperature and improve the high-frequency characteristics. Furthermore, in a case where the subcarrier 14 includes a multilayer substrate, the high frequency wiring can be formed in the inner layer, and thus a groove can also be formed in the region 27. By forming a groove between the driver IC 12 and the optical modulator chip 13 on at least one of the upper surface or the bottom surface of the subcarrier 14, the groove can also serve as a thermal separation groove.

It is desirable to provide a groove for releasing the underfill material also on the subcarrier near the emission point of the waveguide of the optical modulator chip 13. Referring to FIG. 2 again, when the underfill material come out in the vicinity of the chip end surface on the lens side of the optical modulator chip 13, the underfill material adheres to the emission end face, and thus optical coupling with the lenses 23 and 24 may be deteriorated. The groove of one side of the rectangular groove 26-1 of the optical modulator chip 13 on the lens 23 side illustrated in FIG. 3 is also effective for avoiding such a trouble in the optical coupling.

In a case where the subcarrier 14 is formed to have a multilayer structure, it is possible to avoid the influence of the underfill material by configuring the high-frequency line in the inner layer of the subcarrier. Furthermore, when the high frequency wiring is configured in the inner layer, a groove can be formed on the upper surface of the subcarrier at an arbitrary position between the optical modulator chip and the driver IC. It goes without saying that sufficient consideration is required for disconnection of the inner layer wiring, an influence on the characteristic impedance, and the like. On the other hand, in a case where the high frequency wiring is designed with the same line impedance, the signal line width becomes narrow in the inner layer wiring due to the influence of the effective dielectric constant of the subcarrier. Moreover, since the influence of the dielectric loss tangent of the subcarrier is also received, it is desirable that a wiring pattern is present on the outermost surface of the subcarrier 14 when considering only the loss of the high-frequency line.

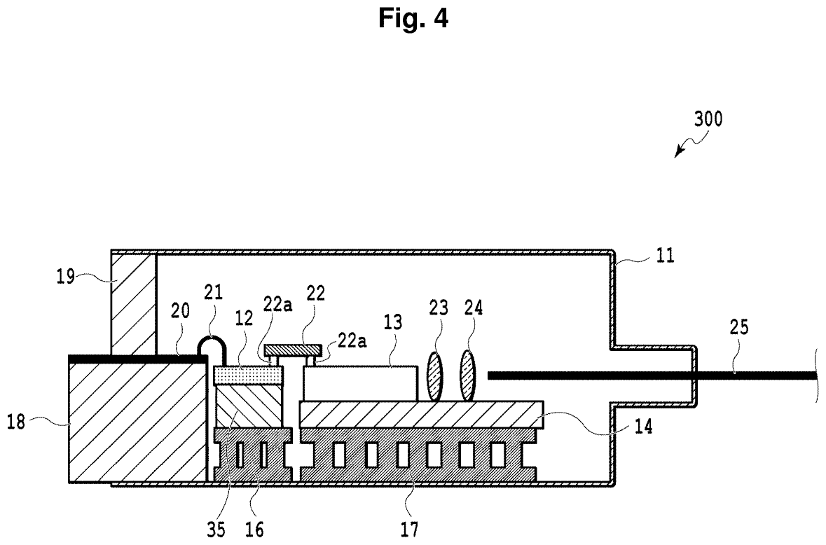

In the arrangement of the spatial optical components in FIG. 3, the lenses 23 and 24 are disposed on a side of the optical modulator chip 13 opposite to the driver IC 12. However, for example, at least one lens can also be disposed on the upper side or the lower side of the optical modulator chip 13 when viewed in the top view of FIG. 4. Furthermore, a PBC may be disposed on a side different from the driver IC. That is, the spatial optical component is mounted above the first Peltier device 17 on a side different from a side of the chip of the optical modulator facing the driver IC 12. A groove for releasing an excess underfill material can be formed in the vicinity of a side of the chip of the optical modulator corresponding to the spatial optical component.

### Second Embodiment

FIG. 4 is a side cross-sectional view illustrating an implementation form of an optical transmitter 300 using the HB-CDM of the present invention.

In practice, it is often difficult to make the driver IC 12 and the optical modulator chip 13 have the same thickness, and in that case, it is preferable to control the thickness by forming the driver IC 12 and the optical modulator chip 13 as separate members as illustrated in FIG. 4.

For example, there is a case where a thickness difference occurs, for example, 100 μm for the driver IC 12 and 300 μm for the optical modulator chip 13. In this case, for example, the optical modulator chip 13 and the driver IC 12 are mounted on the first Peltier device 17 and the second Peltier device 16, respectively, and the height of the upper surface of the driver IC 12 and the height of the upper surface of the optical modulator chip 13 are controlled. For example, the driver IC 12 is mounted on a metal block 15 such as CuW in consideration of heat dissipation and GND stability. By setting the thickness of the metal block 15 and the thickness of the subcarrier 14 on which the optical modulator chip 13 is mounted to, for example, 500 μm for the thickness of the metal block 15 and 300 um for the thickness of the subcarrier 14, the height of the upper surface of the driver IC 12 and the height of the upper surface of the optical modulator chip 13 can be made uniform.

As illustrated in FIG. 4, in a case where separate subcarriers are used for the driver IC and the modulator chip (in a case where the driver IC and the modulator chip are not mounted on the same subcarrier), the thickness of the second Peltier device 16 and the thickness of the first Peltier device 17 do not need to be the same. For example, considering the thermal resistance of the Peltier device, the efficiency increases as the height of the Peltier device is lower. Therefore, it is effective to set the height of the Peltier device on a side where the driver is mounted to be lower than the height of the Peltier device on which the modulator is mounted.

### Third Embodiment

FIG. 5 is a side cross-sectional view illustrating an implementation form of an optical transmitter 400 using the HB-CDM of the present invention.

When the driver IC 12 and the optical modulator chip 13 are mounted with the same thickness, for example, the subcarrier 14 is used in FIG. 2, but as illustrated in FIG. 5, the number of members can be reduced by providing various DC wirings and alignment marks for optical mounting on the AlN substrates on the upper surface of the first Peltier device 17 and the upper surface of the second Peltier device 16 without using the subcarrier 14. Reducing the number of members leads to a decrease in thermal resistance, which is very effective in terms of temperature control.

### Fourth Embodiment

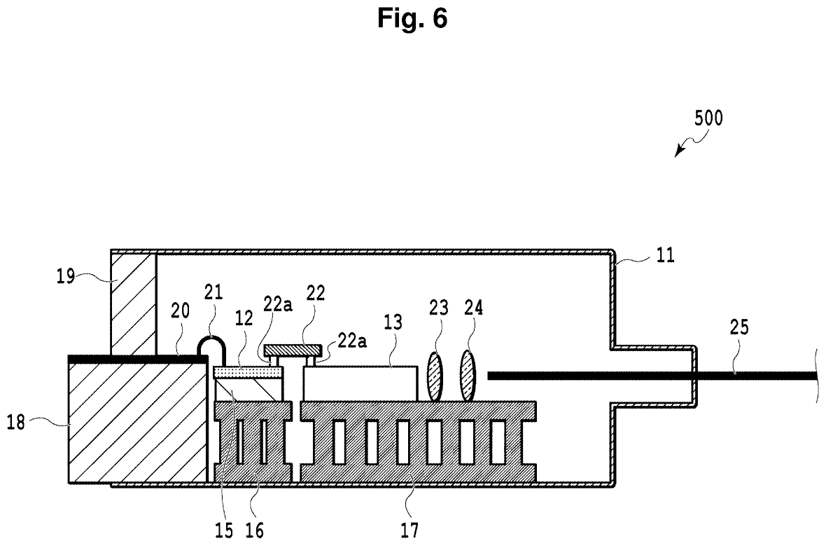

FIG. 6 is a side cross-sectional view illustrating an implementation form of an optical transmitter 500 using the HB-CDM of the present invention.

In a case where the driver IC 12 and the optical modulator chip 13 have different thicknesses, it is possible not to use a subcarrier mounted under the optical modulator chip 13. Note that the present metal block 15 controlled by changing the thickness of the Peltier device may be unprovided. With this configuration, the driver IC 12 is directly formed on the Peltier device.

### Fifth Embodiment

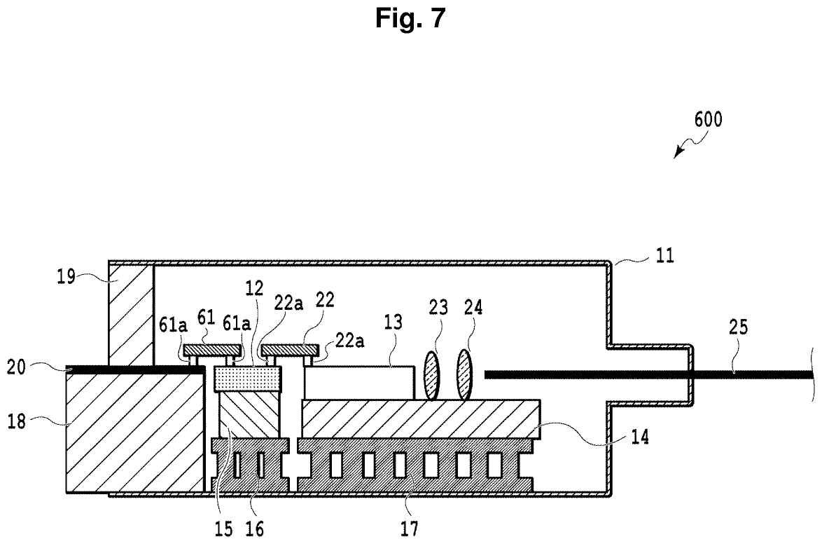

FIG. 7 is a side cross-sectional view illustrating an implementation form of an optical transmitter 600 using the HB-CDM of the present invention.

As illustrated in FIG. 7, the driver IC 12 and the metal pattern 20 on the wiring board base 18 can also be connected by flip-chip mounting using a second wiring board 61 instead of the wire 21.

Also in this case, for the same reason as the difference in height between the upper surface of the optical modulator chip 13 and the upper surface of the driver IC 12 and the inclination of the first wiring board 22, the difference in height between the upper surface of the driver IC 12 and the upper surface of the metal pattern 20 on the upper surface of the wiring board base 18 needs to be 100 μm or less (ideally, 50 μm or less is preferable), and the inclination of the bottom surface of the wiring board relative to the upper surface of the driver IC 12 and the upper surface of the metal pattern 20 on the upper surface of the wiring board base 18 in the height direction needs to be controlled to be within ±3°. The materials used for the first wiring board 22 and the second wiring board 61 may be the same or different. The material of a first bump 22a and the material of a second bump 61a may be the same or different.

However, in terms of cost, it is very effective that the first wiring board 22 and the second wiring board 61 are the same wiring board. In this case, the input/output PAD of the driver IC 12 is assumed to be the same, and the PAD shapes, pitches, and the like of the connection portions of the optical modulator chip 13 and the metal pattern 20 on the upper surface of the wiring board base 18 are made the same. Therefore, the cost can be reduced by using the same wiring board.

However, as illustrated in FIG. 7, in a case where separate subcarriers are used for the driver IC and the modulator chip (in a case where the driver IC and the modulator chip are not mounted on the same subcarrier), the thickness of the second Peltier device 16 and the thickness of the first Peltier device 17 do not need to be the same. For example, considering the thermal resistance of the Peltier device, the efficiency increases as the height of the Peltier device is lower. Therefore, it is effective to set the height of the Peltier device on a side where the driver is mounted to be lower than the height of the Peltier device on which the modulator is mounted.

In the first to fifth embodiments described above, the spatial optical component is described on the premise of the lens mounting, but a configuration other than lens mounting is also acceptable. Furthermore, in addition to the illustrated lenses 23 and 24, the spatial optical component is the fiber fixing member, a polarization beam combiner (PBC), or the like.

### EXAMPLE

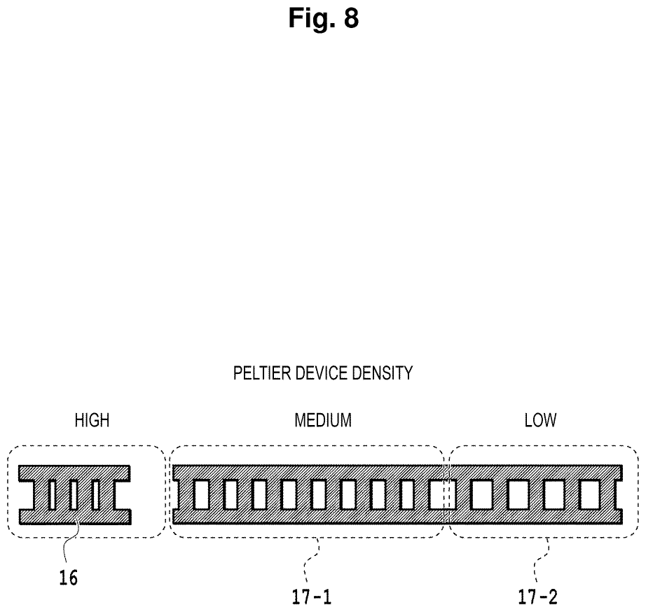

FIG. 8 is a diagram for describing density arrangement of the Peltier device in the optical transmitter of the present invention. In the Peltier device, a large number of n-type semiconductor elements and p-type semiconductor elements are disposed between the upper and lower metal surfaces to realize heat transfer between both surfaces as a whole. Therefore, the arrangement density of the semiconductor elements in the Peltier device can be set according to the heat generation amount of an object to be subjected to the temperature control. Considering the heat generation amount of each unit in the optical transmitter, the driver IC has the largest heat generation amount, and then the optical modulator chip and the spatial optical component are provided in this order. Specifically, the element density of the Peltier device is set such that the relationship of Mounting region of driver IC>Mounting region of optical modulator chip >Mounting region of spatial optical component is satisfied.

As illustrated in FIG. 8, the second Peltier device 16 that controls the driver IC has the highest element density. Furthermore, in the first Peltier device 17 that controls the optical modulator chip, a region immediately below the optical modulator may have a medium density, and a region 17-2 for the spatial optical component or the like may have a low density.

As described above in detail, the optical transmitter of the present invention can suppress the temperature dependency of optical modulation output characteristics and realize a novel configuration and an implementation form of the optical transmitter excellent in high speed.

### INDUSTRIAL APPLICABILITY

The present invention can be used for an optical communication network.

1. An optical transmitter comprising:
an optical modulator;
a driver integrated circuit (driver IC) that supplies a modulation electrical signal for the optical modulator;
a first wiring board mounted face down by flip-chip mounting to connect the optical modulator and the driver IC;
a first Peltier device configured to control a temperature of the optical modulator; and
a second Peltier device configured to control a temperature of the driver IC.

2. The optical transmitter according to claim 1, wherein a difference in height between an upper surface of the driver IC and an upper surface of the optical modulator is 100 μm or less, and an inclination of a bottom surface of the first wiring board relative to the upper surface of the driver IC and the upper surface of the optical modulator in a height direction is within ±3°.

3. The optical transmitter according to claim 1, wherein a distance between a chip of the optical modulator and the driver IC is 300 μm or more and 2 mm or less, and an RF line on the first wiring board is formed in a linear shape.

14. The optical transmitter according to claim 1,
wherein a temperature of the second Peltier device is set to be lower than a temperature of the first Peltier device, and the optical modulator is made of InP,
an upper surface of the first Peltier device is made of aluminum nitride (AlN), and
a paste or a solder layer having thermal conductivity of 30 W/mK or more is provided between the first Peltier device and a chip of the optical modulator and between the second Peltier device and the driver IC.

15. The optical transmitter according to claim 1, wherein the temperature of the first Peltier device is set in a range of 45±10° C., and
the temperature of the second Peltier device is set in a range of 30±10° C.

16. The optical transmitter according to claim 3, wherein a spatial optical component is mounted on the first Peltier device on a side of a chip of the optical modulator opposite to the driver IC, and spatial optical components required for constituting the optical modulator are mounted on the Peltier device on which the optical modulator is mounted, the spatial components comprising a lens, a fiber fixing member, and a polarization beam combiner (PBC), and
the first Peltier device and the second Peltier device are configured such that in-plane densities of an n-type semiconductor element and a p-type semiconductor element satisfy a relationship of the second Peltier device>a region mounted the chip of the optical modulator on the first Peltier device>a region mounted the spatial optical component on the first Peltier device.

17. The optical transmitter according to claim 6, wherein the chip of the optical modulator and the driver IC are mounted in a package with a form of a high-bandwidth coherent driver modulator, HB-CDM,
an electrode pad with a differential signal interface is formed in an electrical signal path of an input portion of the package, the driver IC, and the chip of the optical modulator, and
a difference in height between an upper surface of an RF terrace on which a radio frequency (RF) electrode pad of the input unit is formed and an upper surface of the driver IC is 100 μm or less, the RF electrode pad of the RF terrace and the electrode pad of the driver IC are connected via a second wiring board, and an inclination of a bottom surface of the second wiring board relative to an upper surface of the driver IC and an upper surface of the RF electrode pad in a height direction is within ±3°.

18. The optical transmitter according to claim 1, wherein the driver IC and a chip of the optical modulator are mounted on a same subcarrier, and a thermal separation groove is provided on an upper surface of the subcarrier in a vicinity of at least one of sides facing each other, or provided on at least one of an upper surface or a bottom surface of the subcarrier between the driver IC and the chip of the optical modulator.
